(19) United States
(12) Patent Application Publication
(10) Pub. No.: US 2025/0389818 A1
(43) Pub. Date: Dec. 25, 2025

(54) LASER TRANSCEIVER MODULE AND LIDAR

(71) Applicant: SUTENG INNOVATION TECHNOLOGY CO., LTD., Shenzhen (CN)

(72) Inventor: Kaipeng ZHANG, Shenzhen (CN)

(73) Assignee: SUTENG INNOVATION TECHNOLOGY CO., LTD., Shenzhen (CN)

(21) Appl. No.: 19/239,913

(22) Filed: Jun. 16, 2025

(30) Foreign Application Priority Data
Jun. 24, 2024 (CN) 202410823094.6

(51) Int. Cl. G01S 7/481

(52) U.S. Cl. CPC G01S 7/4813

(57) ABSTRACT

The present application discloses a laser transceiver module and a LiDAR. The laser transceiver module includes a receiving lens and a receiver, the receiving lens is configured to receive an echo light formed after a detection light is reflected by a target object, the receiver has an imaging surface, and the echo light converges on the imaging surface. An effective focal length fm of the receiving lens meets 1.70 mm≤fm≤2.30 mm, and an F value Fm of the receiving lens meets 1≤Fm≤1.7.

### CROSS-REFERENCE TO RELATED APPLICATION

The present application claims the benefit of priority to Chinese Patent Application No. 202410823094.6, filed on Jun. 24, 2024, which is hereby incorporated by reference in its entirety.

### TECHNICAL FIELD

The present application relates to the field of LiDAR technology, and in particular to a laser transceiver module and a LiDAR.

### BACKGROUND

LiDAR is a radar system that uses laser beams to detect the position, speed, and other characteristic quantities of a target. A typical LiDAR generally includes a transmitting module, a receiving module, and a signal processing device. The light source in the transmitting module transmits a detection beam to the target object, and the receiving module receives the echo beam reflected by the target object and outputs the corresponding electrical signal. After the signal processing device processes the electrical signal, the distance, direction, height, speed, attitude, and shape of the target object are obtained, thereby enabling target detection.

In conventional LiDAR systems, fisheye lenses are often employed as transceiver lenses in order to achieve a large field of view. However, such fisheye lenses typically fail to meet the imaging performance requirements necessary for accurate LiDAR operation.

### SUMMARY

Embodiments of the present application provide a laser transceiver module and a LiDAR, which address issues associated with degraded imaging quality and reduced echo light reception capability of the transceiver lens when the field-of-view (FOV) angle of the LiDAR exceeds 180°.

In a first aspect, an embodiment of the present application provides a laser transceiver module. The laser transceiver module includes a receiving lens and a receiver. The receiving lens is used to receive the echo light formed after the detection light is reflected by the target object, the receiver has an imaging surface, and the echo light converges on the imaging surface;

The receiving lens satisfies the conditional formula: 1.70 mm≤fm≤2.30 mm, 1≤Fm≤1.7, where fm is the effective focal length of the receiving lens, and Fm is the F value of the receiving lens.

In some embodiments, the receiving lens includes a first receiving lens, a second receiving lens, a third receiving lens, a fourth receiving lens, and a fifth receiving lens arranged along the optical axis. The distance value from the first receiving lens to the receiver, the distance value from the second receiving lens to the receiver, the distance value from the third receiving lens to the receiver, the distance value from the fourth receiving lens to the receiver, and the distance value from the fifth receiving lens to the receiver decrease sequentially. The first receiving lens and the second receiving lens have negative refractive power, while the third receiving lens, the fourth receiving lens, and the fifth receiving lens have positive refractive power. The fourth receiving lens is an aspherical lens.

In some embodiments, the receiving lens satisfies the conditional formula: 1.0≤fm1/fm2≤2.0, −1.0≤fm2/fm3≤−0.3, 1.6≤fm3/fm4≤2.1, 0≤fm4/fm5≤0.5, where fm1 is the focal length of the first receiving lens, fm2 is the focal length of the second receiving lens, fm3 is the focal length of the third receiving lens, fm4 is the focal length of the fourth receiving lens, and fm5 is the focal length of the fifth receiving lens.

In some embodiments, the laser transceiver module also includes a emission lens and a emitter. The emission lens is used to transmit the detection light generated by the emitter toward the target object. The emitter has a light emitting surface, and the detection light is emitted from the light emitting surface. The emission lens satisfies the condition: 2.0 mm≤fn≤2.90 mm, where fn is the effective focal length of the emission lens.

In some embodiments, the emitting lens includes a first emitting lens, a second emitting lens, a third emitting lens, and a fourth emitting lens arranged along the optical axis. The distance value from the first emitting lens to the emitter, the distance value from the second emitting lens to the emitter, the distance value from the third emitting lens to the emitter, and the distance value from the fourth emitting lens to the emitter increase sequentially. The first emitting lens and the second emitting lens have positive refractive power, while the third emitting lens and the fourth emitting lens have negative refractive power. The first emitting lens or the second emitting lens is an aspherical lens.

In some embodiments, the emitting lens satisfies: 1.6≤fn1/fn2≤1.9, −0.8≤fn2/fn3≤−0.4, 0.5≤fn3/fn4≤0.8, where fn1 is the focal length of the first emitting lens, fn2 is the focal length of the second emitting lens, fn3 is the focal length of the third emitting lens, and fn4 is the focal length of the fourth emitting lens.

In some embodiments, the emitting lens also includes a fifth emitting lens, which is arranged between the second emitting lens and the third emitting lens, and the focal length of the fifth emitting lens is fn5. The emitting lens satisfies: 12.1≤fn1/fn2≤2.5, 0.6≤fn2/fn5≤0.8, 1.4≤fn5/fn3≤1.7, 0.5≤fn3/fn4≤0.7.

In some embodiments, the receiving lens and the emission lens are arranged side by side in the vertical direction, and the optical axis of the receiving lens is parallel to the optical axis of the emission lens, and both are perpendicular to the vertical direction.

In some embodiments, the lens of the receiving lens has a first plane parallel to the optical axis of the receiving lens, and the first plane is perpendicular to the vertical direction; or, the lens of the emission lens has a second plane parallel to the optical axis of the emission lens, and the second plane is perpendicular to the vertical direction.

In a second aspect, the present application provides a LiDAR, including a shell and a laser transceiver module as described above, where the shell is used to install the laser transceiver module.

Based on the laser transceiver module and LiDAR disclosed in the present application, by setting the effective focal length fm of the receiving lens to satisfy 1.70 mm≤fm≤2.30 mm, and setting the F value Fm of the receiving lens to satisfy 1≤Fm≤1.7, the size of the receiving surface of the receiver and the entrance pupil diameter of the receiving lens can be controlled within an appropriate range, so that the receiving lens has a larger receiving field of view and a suitable effective focal length, which can meet the good imaging quality requirements of the LiDAR.

### BRIEF DESCRIPTION OF THE DRAWINGS

In order to more clearly illustrate the embodiments of the present application or the technical solutions in the prior art, a brief description of the accompanying drawings is provided below. The accompanying drawings illustrate only certain embodiments of the present application, and those skilled in the art will understand that other drawings may be derived from these illustrations without departing from the scope of the present application and without requiring inventive effort.

FIG. 1a is a schematic side view of the structure of a receiving lens and an emission lens arranged side by side in a vertical direction according to an embodiment of the present application;

FIG. 1b is a schematic diagram of a top view of the structure in which a receiving lens and an emission lens are arranged side by side in a horizontal direction in the related art;

FIG. 2 is a schematic diagram of the main structure of the receiving lens and the emission lens of an embodiment of the present application, arranged side by side in the vertical direction;

FIG. 3 is a schematic diagram of the structure of the lens of the receiving lens of Example 1;

FIG. 4 is a field curvature curve diagram of the receiving lens of Example 1;

FIG. 5 is a distortion curve diagram of the receiving lens of Example 1;

FIG. 6 is a graph showing the modulation transfer function (MTF) of the receiving lens of Example 1;

FIG. 7 is a relative illumination curve diagram of the receiving lens of Example 1;

FIG. 8 is a schematic diagram of the structure of the lens of the emission lens of Example 1;

FIG. 9 is a full-field point diagram of the emission lens of Example 1;

FIG. 10 is a schematic diagram of the structure of the lens of the receiving lens of Example 2;

FIG. 11 is a field curvature curve diagram of the receiving lens of Example 2;

FIG. 12 is a distortion curve diagram of the receiving lens of Example 2;

FIG. 13 is a graph showing the modulation transfer function (MTF) of the receiving lens of Example 2;

FIG. 14 is a relative illumination curve diagram of the receiving lens of Example 2;

FIG. 15 is a schematic diagram of the structure of the lens of the emission lens of Example 2; and

FIG. 16 is a full-field-of-view point diagram of the emission lens of the second embodiment.

### REFERENCE NUMERALS

100, laser emission module; 110, emitter; C, light emitting surface; 120, emission lens; 200, laser receiving module; 210, receiver; M, imaging surface; 220, receiving lens.

### DETAILED DESCRIPTION

In order to further clarify the purpose, technical solutions, and advantages of the present application, a more detailed description is provided below with reference to the accompanying drawings and exemplary embodiments. It should be understood that the specific embodiments described herein are intended solely for illustrative purposes and are not intended to limit the scope of the present application in any way.

The detection performance of vehicle-mounted LiDAR is influenced by various factors, including optical power, stray light, receiving aperture size, focal length, and field of view (FOV). A larger FOV of the LiDAR transceiver lens facilitates the acquisition of more target information. However, when the FOV exceeds 180°, challenges arise in controlling the physical dimensions of the lens, increasing the complexity of design and manufacturing. To achieve high resolution under such conditions, it is often necessary to design lenses with substantial aperture differences between adjacent lens elements, and to employ a receiver of suitable size to meet imaging requirements. Such lenses, having aperture differences significantly greater than those of conventional designs, tend to exhibit poor assembly performance and reduced adaptability in demanding environments. Accordingly, a key design challenge is to develop ultra-wide-angle lenses that balance a large FOV with compactness and manufacturability. In view of this, embodiments of the present application provide a laser transceiver module and a LiDAR system configured to improve the imaging quality of transceiver lenses when the FOV exceeds 180°.

In some embodiments, the LiDAR includes a shell and a laser transceiver module, and the shell is used to install the laser transceiver module to fix the laser transceiver module in the shell.

In some embodiments, the laser transceiver module includes a laser emission module and a laser receiving module. The laser emission module is used to emit detection light to detect the target object, and the laser receiving module is used to receive the echo light formed by the target object reflecting the detection light.

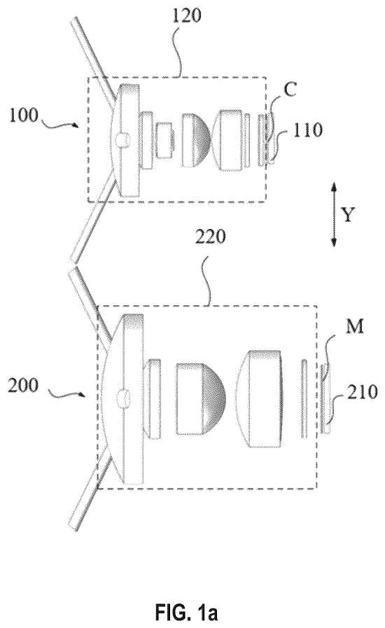

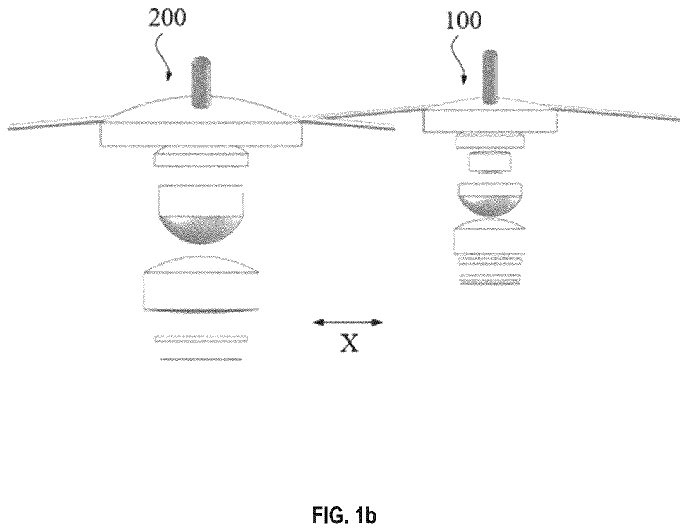

As shown in FIG. 1a, laser emission module 100 includes an emitter 110 and an emission lens 120. The emitter 110 is used to emit detection light. The emitter has a light-emitting surface C. The emission lens 120 is arranged on the light-emitting side of the emitter 110 to receive the detection light emitted by the emitter 110. The emission lens 120 includes at least one lens having a refracting force on light to diverge the detection light and project it to the target object within the emission field of view. In some embodiments, the laser receiving module 200 includes a receiver 210 and a receiving lens 220. The receiver 210 has an imaging surface M. The receiving lens 220 is arranged corresponding to the imaging surface M. The receiving lens 220 is used to receive the echo light reflected by the target object within the receiving field of view, and the receiving lens 220 includes at least one lens having a refracting force on light to converge the echo light to the imaging surface M. The imaging surface M is used to receive the echo light reflected by the target object.

In some embodiments, the area covered by the emission field of view of the laser emission module 100 of the LiDAR at least partially overlaps with the area covered by the reception field of view of the laser receiving module 200, so that when the laser emission module 100 emits an outgoing laser to a target object located in the overlapping detection area, the echo light reflected by the target object can be received by the laser receiving module 200, and the position information of the target object can be obtained based on the echo light.

The following description takes the example that the LiDAR includes only one laser receiving module 200. It can be understood that in other embodiments of the present application, multiple laser receiving modules 200 can be included, and correspondingly, multiple laser emission modules 100 can also be included.

In some embodiments, the size of the imaging surface M of the receiver 210 in the laser receiving module 200 in a single direction (including the horizontal direction and the vertical direction) is H, the effective focal length of the receiving lens 220 is fm, and the receiving field angle of the laser receiving module 200 is 0. The optical axis of the receiving lens 220 passes through the geometric center of the receiver 210, so the maximum image height h (half image height) of the laser receiving module 200 in the above single direction satisfies h=H/2, and the half field angle θ of the receiving lens 220 satisfies θ=θ/2. In some embodiments, h, fm, and θ satisfy: h=fm*θ. Based on this, when the size of the receiver 210 is relatively determined, the maximum image height h of the laser receiving module 200 is also determined accordingly; at the same time, the half receiving field angle θ (in radians) of each laser receiving module 200 is inversely proportional to the effective focal length fm of the receiving lens 220. Therefore, by reducing the focal length fm of the receiving lens 220 in the laser receiving module 200, the above half field angle θ can be increased. That is, the receiving field angle θ of the laser receiving module 200 can be increased. Since the field angle of the laser emission module 100 corresponds to the field angle of the laser receiving module 200, the field angle of the laser emission module 100 will also increase, thereby increasing the field angle of the entire LiDAR and improving the detection performance.

In some embodiments, the receiving lens 220 includes at least one lens with a refracting force on light arranged sequentially from the object side to the image side along the optical axis, and the receiving lens 220 satisfies the conditional formula: 1.70 mm≤fm≤2.30 mm, where fm is the effective focal length of the receiving lens 220. According to h=fm*θ, when the size of the receiver 210 is relatively determined, by selecting fm in the range of 1.70 mm˜2.30 mm, the LiDAR can have good imaging quality when the half-viewing angle θ of the laser receiving module 200 is between 90° ˜120° (the radian value corresponding to 90° is π/2, and the radian value corresponding to 120° is 2π/3). That is, when the field of view of the laser receiving module 200 is between 180° ˜240°. In some embodiments, the maximum image height h (half-image height) of the laser receiving module 200 in a single direction satisfies 2.7 mm≤h≤4.8 mm.

In some embodiments, the receiving lens 220 also satisfies: 1≤Fm≤1.7, where Fm is the F value of the receiving lens 220, that is, the F number of the aperture JST of the receiving lens 220. It can be understood that the ranging of the LiDAR depends on the entrance pupil diameter of the receiving lens 220. The larger the entrance pupil diameter, more light will enter, and the better the long-distance detection imaging effect. Among them, the entrance pupil diameter=fm/Fm, and the entrance pupil diameter is proportional to the focal length fm of the receiving lens 220. In order to realize the design of a large entrance pupil diameter under a large viewing angle, the range of Fm of the receiving lens 220 is selected to be 1.0˜1.7, so as to increase the effective focal length f of the receiving lens 220 while increasing the entrance pupil diameter of the receiving lens 220. In this way, the amount of light entering can be increased while the field of view is large, and the effect of a large entrance pupil diameter can be achieved. The larger the entrance pupil diameter of the receiving lens 220 is, the larger the corresponding aberration will be. Setting Fm in the range of 1.0 to 1.7 facilitates controlling the entrance pupil diameter within an appropriate range to prevent the entrance pupil diameter from being too large, resulting in large aberrations.

In some embodiments, the receiving lens 220 also satisfies the conditional formula: 5.7≤TTL/h≤6.1, where TTL is the distance in the optical axis direction from the object side of the lens of the receiving lens 220 facing the target to the image side of the lens facing the imaging surface M. By setting TTL/h in the range of 5.7 to 6.1, while meeting the arrangement spacing requirements of each lens of the receiving lens 220, it is convenient to control the volume of the laser receiving module in the optical axis direction to prevent the volume of the LiDAR from being too large. In some embodiments, TTL satisfies: 17.0 mm≤TTL≤22.0 mm.

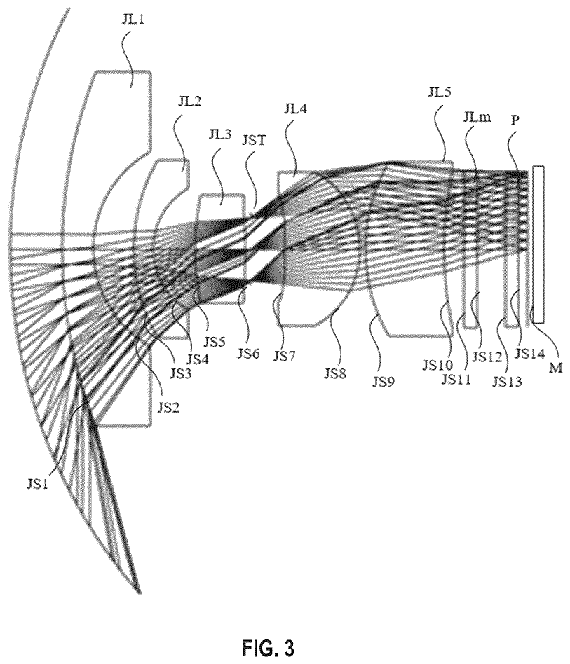

As shown in FIG. 3, the receiving lens 220 includes a first receiving lens JL1, a second receiving lens JL2, a third receiving lens JL3, a fourth receiving lens JL4, and a fifth receiving lens JL5, which are arranged sequentially from the object side to the image side along the optical axis. That is, the distance value from the first receiving lens JL1 to the receiver 210, the distance value from the second receiving lens JL2 to the receiver 210, the distance value from the third receiving lens JL3 to the receiver 210, the distance value from the fourth receiving lens JL4 to the receiver 210, and the distance value from the fifth receiving lens JL5 to the receiver 210 decrease sequentially.

The first receiving lens JL1 and the second receiving lens JL2 respectively have negative refractive power, so as to reduce the large-angle light after the large-angle light enters the receiving lens 220, which helps the subsequent optical elements to converge the light and correct the aberration, and helps the receiving lens 220 to have a large field of view. The first receiving lens JL1 and the second receiving lens JL2 can also project the edge light of the field of view to the rear lens at a small angle, which helps to reduce the field curvature, astigmatism, and other aberrations of the light entering the third receiving lens JL3, the fourth receiving lens JL4, and the fifth receiving lens JL5 at the rear.

The third receiving lens JL3, the fourth receiving lens JL4, and the fifth receiving lens JL5 have positive refractive power, and are used to converge the light to the imaging surface M, to correct aberrations, and further to adjust the light so that the light can be projected to the imaging surface M of the receiver 210 at a small angle, with good imaging effect. The first receiving lens JL1 and the second receiving lens JL2 with negative refractive power receive incident light at a large angle, and the third receiving lens JL3, the fourth receiving lens JL4, and the fifth receiving lens JL5 are combined to adjust the light, so that the receiving lens 220 has a large receiving field angle and good imaging effect.

In general, aberrations are divided into spherical aberration, coma, astigmatism, field curvature, distortion, and chromatic aberration. Since the LiDAR band is very narrow, chromatic aberration can be ignored. Other types of aberrations will increase due to the increase in the diameter of the lens. In order to reduce aberrations, it is usually necessary to increase the number of lenses. However, increasing the number of lenses will lead to higher costs. At the same time, the increase in the number of lenses will affect the transmittance of the lens, resulting in a decrease in ranging, an increase in stray light, and other factors. Conventional spherical lenses only have variables such as curvature radius, thickness, refractive index of the material, and Abbe number in design dimensions, so the effect of correcting aberrations is relatively limited. The present solution considers using aspherical lenses instead of spherical lenses. In addition to the above variables, aspherical surfaces also have more than 10 high-order coefficients to correct aberrations, so usually the number of aspherical surfaces is equivalent to at least two spherical surfaces. Therefore, the present solution considers using aspherical lenses to reduce the number of lenses of the receiving lens 220 and improve the transmittance of the receiving lens 220. In some embodiments, the fourth receiving lens JL4 is an aspheric lens, that is, the lens located at the rear end (adjacent to the receiver 210) is selected to have an aspheric surface, which is used to focus the echo light to the receiving surface and has a good correction effect on the echo light. In particular, under large field-of-view conditions, where edge field distortion is more likely, the use of an aspheric surface assists in compressing such distortion and improving imaging quality. In some embodiments, the fourth receiving lens JL4 can be an even-order aspheric lens. Detailed parameters of the aspheric design are provided in Table 2 and Table 6 described below.

In some embodiments, the receiving lens 220 satisfies the conditional formula: 1.0≤fm1/fm2≤2.0, −1.0≤fm2/fm3<−0.3, 1.6≤fm3/fm4<2.1, 0≤fm4/fm5≤0.5, where fm1 is the focal length of the first receiving lens JL4, fm2 is the focal length of the second receiving lens JL2, fm3 is the focal length of the third receiving lens JL3, fm4 is the focal length of the fourth receiving lens JL4, and fm5 is the focal length of the fifth receiving lens JL5. By satisfying the above conditional formula in the focal length of each lens of the receiving lens 220, the receiving lens 220 has good imaging quality.

In some embodiments, the object side surface of the first receiving lens JL1 is convex at the near optical axis, and the image side surface is concave at the near optical axis. The focal length fm1 of the first receiving lens JL2 satisfies: −8.40 mm≤fm1≤−7.36 mm. The object side surface of the second receiving lens JL2 is convex at the near optical axis, and the image side surface is concave at the near optical axis. The focal length fm2 of the second receiving lens JL2 satisfies: −6.70 mm≤fm2≤−5.50 mm, so that the first receiving lens JL1 and the second receiving lens JL2 can better receive large-angle light at the front end. The object side surface and the image side surface of the third receiving lens JL3 are both convex at the near optical axis, and the focal length fm3 of the third receiving lens JL3 satisfies: 10.15 mm≤fm3≤10.50 mm. The object side surface and the image side surface of the fourth receiving lens JL4 are both convex at the near optical axis, and the focal length fm4 of the fourth receiving lens satisfies: 5.10 mm≤fm435.45 mm. The object side surface and the image side surface of the fifth receiving lens JL5 are both convex at the near optical axis, and the focal length fm4 of the fifth receiving lens JL5 satisfies: 13.01 mm≤fm5≤15.60 mm. The third receiving lens JL3, the fourth receiving lens JL4, and the fifth receiving lens JL5 further adjust the light at the rear end to improve the aberration.

In some embodiments, the receiving lens 220 further satisfies: 0°<CRA≤8.0°, where CRA is the angle between the main ray entering the imaging plane M and the optical axis. By controlling the main ray angle to be no higher than 8.0°, the receiving efficiency of the main ray can be made higher. Accordingly, the receiving efficiency of the echo light incident at other angles to the optical axis can also be improved.

In order to minimize the deformation and distortion of the point cloud image, the focal length of each lens of the receiving lens 220, the distance between lenses and the material of the lenses are adjusted, such that the distortion of the receiving lens 220 is controlled within 19.04%, and the deformation and distortion of the image is controlled within an acceptable range.

In some embodiments, the receiving lens 220 further includes a lens barrel, and the first receiving lens JL1 to the fifth receiving lens JL5 are all disposed in the light-through hole of the lens barrel. The receiving lens 220 may further include an aperture, which is mounted on the lens barrel and located between the image side of the third receiving lens JL3 and the object side of the fourth receiving lens JL4.

In some embodiments, the laser receiving module 200 further includes a protective glass JLm and a filter P, and the filter P and the protective glass JLm are arranged between the image side and the imaging surface M of the fifth receiving lens JL5. The filter P may be a band pass filter, which allows the echo light to pass through so that the echo light can reach the receiving surface of the receiver 210. At the same time, the filter P prevents the interference light signal outside the echo light width from passing through, so as to reduce the proportion of the interference light falling on the receiver 210, thereby reducing the influence of the receiver 210 on the echo light reception. The protective glass JLm is arranged adjacent to the imaging surface M of the receiver 210 to protect the receiver 210. The filter P and the protective glass JLm can be assembled together with each lens to serve as a part of the receiving lens 220. For example, in some embodiments, each lens in the receiving lens 220 is installed in the lens barrel, and the filter P and the protective glass JLm are installed at the image end of the lens barrel. In some embodiments, the filter P and the protective glass JLm may also be components that do not belong to the receiving lens 220. In this case, the filter P and the protective glass JLm may be installed between the laser receiving module 200 and the receiver 210 when the receiving lens 220 and the receiver 210 are assembled into the laser receiving module 200. The filter may be arranged adjacent to the protective glass or on the object side of the first receiving lens.

In some embodiments, the first receiving lens JL1 to the fifth receiving lens JL5 are all glass lenses. In some embodiments, the first receiving lens JL1 to the fifth receiving lens JL5 can also be a combination of glass lenses and plastic lenses. That is, some of the lenses in the first receiving lens JL1 to the fifth receiving lens JL5 are glass lenses and the other parts are plastic lenses. In some embodiments, the lens at the front end (i.e., the lens away from the receiver 210) is a glass lens.

The light emission module includes an emission lens 120 and an emitter 110. The emission lens 120 is used to emit the detection light generated by the emitter 110 toward the target object. The emitter 110 has a light emitting surface C, and the detection light is emitted from the light emitting surface C.

In some embodiments, the emission lens 120 includes at least one lens that has a refracting force on light. The lens of the emission lens 120 may include at least one of a glass lens and a plastic lens, and the surface shape of the lens of the emission lens 120 may also include at least one of a spherical surface and an aspherical surface.

The field of view angle corresponding to the laser emission module 100 composed of the emission lens 120 and the emitter 110 (such as a laser) matches the field of view angle corresponding to the laser receiving module 200. In order to cooperate with the receiving lens 220 to have a large receiving field of view, the emission lens 120 is also set to have a large emission field of view. Specifically, the emission lens 120 satisfies the conditional formula: 2.0 mm≤fn≤2.90 mm, fn is the effective focal length of the emission lens 120. Similarly, according to h=fn*θ, when the size of the light-emitting surface C of the emitter 110 is relatively determined, by selecting fn in the range of 2.0 mm˜2.90 mm, the half field of view angle of the laser emission module 100 can be between 90°˜120°. When the field of view angle of the laser emission module 100 is between 180°˜240°, the emission lens 120 has good optical performance, thereby cooperating with the laser receiving module 200, so that the LiDAR has a larger emission field of view angle.

The emission lens 120 also satisfies the condition: 1≤Fn≤1.7, where Fn is the F value of the emission lens 120. In the embodiments of the present application, in order to achieve a large entrance pupil diameter under a wide field-of-view condition, the design is based on the relationship: entrance pupil diameter=fn/Fn. Accordingly, the range of Fn of the emission lens 120 is selected to be 1.0 to 1.7. This configuration increases the effective focal length f of the emission lens 120 while simultaneously increasing the entrance pupil diameter of the receiving lens 220, thereby enhancing light intake under a wide field of view and achieving a large entrance pupil diameter.

In some embodiments, the emission lens 120 includes a first emission lens FL1, a second emission lens FL2, a third emission lens FL3, and a fourth emission lens FL4, which are arranged sequentially from the image side to the object side along the optical axis. That is, the distance value from the first emission lens FL1 to the emitter 110, the distance value from the second emission lens FL2 to the emitter 110, the distance value from the third emission lens FL3 to the emitter 110, and the distance value from the fourth emission lens FL4 to the emitter 110 increase sequentially.

The first emitting lens FL1 and the second emitting lens FL2 have positive refractive power, and the third emitting lens FL3 and the fourth emitting lens FL4 have negative refractive power. In this way, the first emitting lens FL1, the second emitting lens FL2, the third emitting lens FL3, and the fourth emitting lens FL4 cooperate to adjust the emission angle of the detection light, so that the detection light can be projected at a large angle to cover a wider range of targets. At least one of the first emitting lens FL1 and the second emitting lens FL2 can be an aspherical lens, so that the front end of the emission lens 120 can adjust the light and reduce the negative impact caused by the aberration generated by the detection light passing through the front lens and entering the rear lens and being enlarged.

In some embodiments, the emission lens 120 satisfies: 1.6≤fn1/fn2≤1.9, −0.8≤fn2/fn3≤−0.4, 0.5≤fn3/fn4<0.8, where fn1 is the focal length of the first emission lens FL1, fn2 is the focal length of the second emission lens FL2, fn3 is the focal length of the third emission lens FL3, and fn4 is the focal length of the fourth emission lens FL4. By selecting the first emission lens FL1 to the fourth emission lens FL4 of the emission lens 120 to satisfy the above conditional expressions, the quality of the detection light emitted by the emission lens 120 is higher, and the target object can be detected more accurately.

The image side and object side of the first emitting lens FL1 are both convex at the near optical axis, and the focal length fn1 of the first emitting lens FL1 satisfies: 12.60 mm≤fn1≤16.55 mm; the image side and object side of the second emitting lens FL2 are both convex at the near optical axis, and the focal length fn2 of the second emitting lens FL2 satisfies: 7.01 mm≤fn2≤7.40 mm, so that the first emitting lens FL1 and the second emitting lens FL2 can better adjust the light at the front end and improve the aberration. The image side of the third emitting lens FL3 is concave at the near optical axis, and the object side is convex at the near optical axis. The focal length fn3 of the third emitting lens FL3 satisfies: −10.85 mm≤fn3≤−7.30 mm. The image side surface of the fourth emitting lens is concave at the near optical axis, and the object side surface is convex at the near optical axis. The focal length fn4 of the fourth emitting lens FL4 satisfies: −14.10 mm≤fn4<−12.32 mm. The third emitting lens FL3 and the fourth emitting lens FL4 further adjust the light at the rear end to improve the detection light so that it can be emitted at a large angle.

In some embodiments, the emission lens 120 also includes a fifth emission lens FL5, which is disposed between the second emission lens FL2 and the third emission lens FL3. The focal length of the fifth emission lens FL5 is fn5. The emission lens 120 satisfies: 12.1<fn1/fn2≤2.5, 0.6≤fn2/fn5≤0.8, 1.4≤fn5/fn3≤1.7, 0.5≤fn3/fn4<0.7. By adding the fifth emission lens FL5, the detection light is further adjusted so that the detection light emitted by the emission lens 120 can detect the target object more accurately.

The image side surface and the object side surface of the fifth emitting lens FL5 are both convex surfaces at the near optical axis. The focal length fn5 of the fifth emitting lens FL5 satisfies: 11.10 mm≤fn5≤11.60 mm. The fifth emitting lens FL5 can cooperate with the first emitting lens FL1 and the second emitting lens FL2 to better adjust the light at the front end so that the light can be emitted at a large angle after being transmitted through the rear end lens.

In some embodiments, the laser emission module 100 may further include a protective glass and a filter FLn for protecting the emitter 110. The filter FLn is used to filter out the interference of stray light so that the laser emission module 100 emits detection light of a preset band. In addition, similar to the receiving lens 220, the lens of the emission lens 120 close to the emitter 110 may be made of plastic, and the remaining lenses may be made of glass, or all the lenses of the emission lens 120 may be made of glass.

It is understandable that the detection light emitted by the emission lens 120 is divergent, and correspondingly, the receiving lens 220 receives the echo light in a divergent shape. When the emission lens 120 is close to the receiving lens 220, the emission lens 120 and the receiving lens 220 are prone to mutual shielding, or other structural parts of the LiDAR located near the emission lens 120 and the receiving lens 220 will shield the light, thereby affecting the field of view of the LiDAR. The field of view of the LiDAR includes a horizontal field of view and a vertical field of view. As shown in FIG. 1b, when the laser emission module 100 and the laser receiving module 200 are arranged side by side along the horizontal direction X, since the horizontal field of view angle of the LiDAR transceiver module is greater than 180 degrees, and the detection light received by the laser receiving module 200 in the horizontal field of view direction will be offset, the optical path of the laser emission module 100 and the optical path of the laser receiving module 200 are mutually shielded in the horizontal direction, and the field of view of the LiDAR transceiver module will be affected. In some embodiments, as shown in FIG. 1a, the emission lens 120 and the receiving lens 220 are stacked along the vertical direction Y. The optical axis of the receiving lens 220 is parallel to the optical axis of the emission lens 120 and is perpendicular to the vertical direction Y. Since the vertical field of view angle of the LiDAR transceiver module is less than 180 degrees, and the detection light received by the laser receiving module 200 in the vertical field of view direction will be offset, the optical path of the laser emission module 100 and the optical path of the laser receiving module 200 do not block each other in the vertical direction, and at the same time, the two do not block each other in the horizontal direction, thereby satisfying the requirement that the LiDAR has a large field of view in the horizontal direction X.

The field of view of the LiDAR is affected not only by the arrangement direction of the emission lens 120 and the receiving lens 220, but also by the shape of the effective light-transmitting area of the lens of the emission lens 120 and the shape of the effective light-transmitting area of the lens of the receiving lens 220. For example, when the shape of the effective light-transmitting area of the lens is circular, the outer contour of the light passing through the lens is circular. The lenses selected for the emission lens 120 and the receiving lens 220, in some embodiments, both include an optical portion 310 and a mounting portion 320. The mounting portion 320 is integrally formed on the optical portion 310 at the periphery of the optical portion 310, and is used to be mounted on the lens barrel. The optical portion 310 has an effective light-transmitting area.

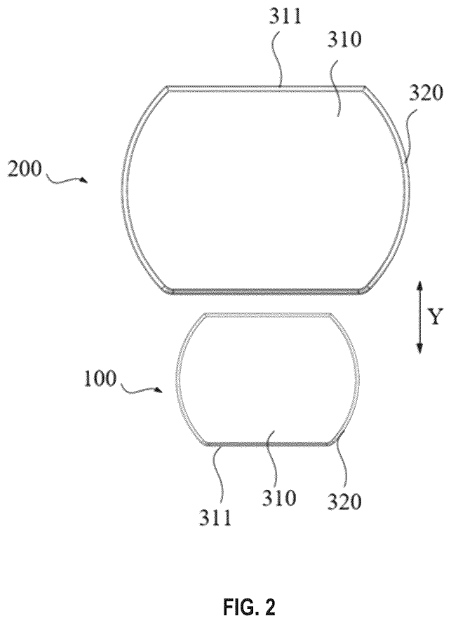

In some embodiments, as shown in FIG. 2, the lens of the receiving lens 220 has a first plane 311 parallel to the optical axis of the receiving lens 220, and the first plane 311 is perpendicular to the vertical direction Y. The first plane 311 may be formed by only a portion of the outer surface of the mounting portion 320 of the lens of the receiving lens 220. For example, when processing the lens of the receiving lens 220, the mounting portion 320 of the lens is cut off; or the first plane 311 may be formed by the mounting portion 320 of the lens of the receiving lens 220 and a portion of the outer surface of the optical portion 310. That is, when processing the lens of the receiving lens 220, both the mounting portion 320 of the lens and the optical portion 310 are cut off.

In some embodiments, the optical axis of the receiving lens 220 passes through the geometric center of the receiving surface M, and the size h of the receiving surface M of the receiver 210 is recorded as h1 including h1x and h1y, where h1x is the size of the receiving surface M in the horizontal direction X, and h1y is the size of the receiving surface M in the vertical direction Y. When the lens of the receiving lens 220 has a first plane 311, h1y>h1x.

In some embodiments, the lens of the emission lens 120 has a second plane 312 parallel to the optical axis of the emission lens 120, and the second plane 312 is perpendicular to the vertical direction. The second plane 312 is formed by a portion of the outer surface of the mounting portion 320 of the lens of the emission lens 120; or, the second plane 312 is formed by the mounting portion 320 of the lens of the emission lens 120 and a portion of the outer surface of the optical portion 310. The processing method of the lens of the emission lens 120 with the second plane 312 is the same as the processing method of the lens of the receiving lens 220 with the first plane 311.

In some embodiments, the optical axis of the emission lens 120 passes through the geometric center of the light emitting surface C, and the size h of the light emitting surface C of the emitter 110 is recorded as h2 including h2x and h2y, where h2x is the size of the light emitting surface C in the horizontal direction X, and h2y is the size of the light emitting surface C in the vertical direction Y. When the lens of the receiving lens 220 has a second plane 312, h2y>h2x.

In some embodiments, when the lens of the receiving lens 220 has a first plane 311, and the lens of the emission lens 120 has a second plane 312, the first plane 311 and the second plane 312 are both perpendicular to the vertical direction Y, and the emission lens 120 and the receiving lens 220 are stacked in the vertical direction. In addition to meeting the requirements of the LiDAR for a large horizontal field of view angle and a small vertical field of view angle, it can also effectively reduce the size of the LiDAR.

The following will refer to the accompanying drawings and tables, combined with specific numerical values to introduce the assembly structure of the laser transceiver module of the present technical solution.

The meanings of the symbols shown in the examples are as follows.

FS1, FS3, FS5, FS7, FS9, and FS11 are the numbers of the object side surfaces of the filter SLn, the first emitting lens FL1, the second emitting lens FL2, the third emitting lens FL3, the fourth emitting lens FL4, and the fifth emitting lens FL5 of the emission lens 120, respectively. FS2, FS4, FS6, FS8, FS10, and FS12 are the numbers of the image side surfaces of the filter SLn, the first emitting lens FL1, the second emitting lens FL2, the third emitting lens FL3, the fourth emitting lens FL4, and the fifth emitting lens FL5 of the emission lens 120, respectively.

JS1, JS3, JS5, JS7, JS9, and JS11 are respectively the numbers of the first receiving lens JL1, the second receiving lens JL2, the third receiving lens JL3, the fourth receiving lens JL4, the fifth receiving lens JL5, and the object side of the filter SLm of the receiving lens 220. JS2, JS4, JS6, JS8, JS10, and JS12 are respectively the numbers of the first receiving lens JL1, the second receiving lens JL2, the third receiving lens JL3, the fourth receiving lens JL4, the fifth receiving lens JL5, and the image side of the filter SLm.

When the object side or image side of the first emitting lens FL1, the object side or image side of the second emitting lens FL2, and the object side or image side of the fourth receiving lens JL4 are even-order aspheric surfaces, the even-order aspheric surfaces satisfy the aspheric surface formula of Mathematical Formula 1:

$$Mathematical formula 1$$

$$z = \frac{{cr}^{2}}{1 + \sqrt{1 - ( 1 + k ) {c}^{2} {r}^{2}}} + {A}_{2} {r}^{2} + {A}_{4} {r}^{4} + {A}_{6} {r}^{6} + {A}_{8} {r}^{8} + {A}_{10} {r}^{10} + {A}_{12} {r}^{12} + {A}_{14} {r}^{14} + {A}_{16} {r}^{16}$$

In the above formula 1, K is the cone constant (Conic Conant), “A2,” “A4,” “A6,” “A8,” “A10,” “A12,” “A14,” and “A16” represent the 2nd, 4th, 6th, 8th, 10th, 12th, 14th, and 16th order aspheric coefficients respectively; r is the distance from any point on the aspheric surface to the optical axis; c is the near optical axis curvature at the vertex of the aspheric surface; and Z is the vector height of the distance from the vertex of the aspheric surface when the aspheric surface is at a height of r along the optical axis.

### Embodiment 1

### (I) Receiving Lens

The structural schematic diagram of the receiving lens is shown in FIG. 3. The receiving lens includes a first receiving lens JL1, a second receiving lens JL2, a third receiving lens JL3, a fourth receiving lens JL4, a fifth receiving lens JL5, a filter SLm, and a protective glass P arranged sequentially from the object side to the image side along the optical axis. The imaging surface M is located on the side of the protective glass P away from the fifth receiving lens JL5. The aperture ST is arranged between the image side surface JS6 of the third receiving lens JL3 and the object side surface JS7 of the fourth receiving lens JL4. The filter SLm is a bandpass filter.

Among them, the first receiving lens JL1 has a negative refractive power, the object side surface JS1 of the first receiving lens JL1 is a convex surface at the near optical axis, and the image side surface JS2 is a concave surface at the near optical axis. The second receiving lens JL2 has a negative refractive power, the object side surface JS3 of the second receiving lens JL2 is a convex surface at the near optical axis, and the image side surface JS4 is a concave surface at the near optical axis. The third receiving lens JL3 has a positive refractive power, and the object side surface JS5 and the image side surface JS6 of the third receiving lens JL3 are both convex surfaces at the near optical axis. The fourth receiving lens JL4 has a positive refractive power, the object side surface JS7 of the fourth receiving lens JL4 is a concave surface at the near optical axis, and the image side surface JS8 is a convex surface at the near optical axis. The object side surface JS9 of the fifth receiving lens JL5 is a convex surface at the near optical axis, and the image side surface JS10 is a concave surface at the near optical axis.

The effective focal length, refractive index, and Abbe number of the receiving lens in Example 1 are based on light with a wavelength of 0.9650 μm. The relevant parameters of the receiving lens are shown in Table 1.

In Table 1 and the following Tables 3 and 5, the relevant parameters are as follows: fm is the effective focal length of the receiving lens 220, Fm is the aperture value of the receiving lens 220, Dm is the maximum effective light-passing diameter of the object side surface JS1 of the first receiving lens JL1, TTLm is the total optical length of the receiving lens 220, θm is half of the maximum field of view of the receiving lens 220 in the horizontal direction, and h1x is half of the maximum linear dimension of the receiving surface M of the receiver 210 in the horizontal direction.

In addition, regarding the parameters in the thickness d column in Table 1 and the following Tables 3, 5, and 7, each lens includes two thickness parameters from top to bottom, the first thickness parameter of each lens is the thickness of the lens on the optical axis, and the second thickness parameter of each lens is the distance from the image side of the lens to the object side of the next optical device from the object side to the image side in the optical axis direction.

TABLE 1
Embodiment 1
fm = 2.01 mm; Fm value = 1.7; θm = 105°; TTLm =
17.91 mm; h1x = 2.98 mm; Dm = 13.6 mm; CRA < 8.0°

| | | | Curvature | | | Refractive | Abbe | Effective |
|---|---|---|---|---|---|---|---|---|
| | Surface | Surface | radius | Thickness | | index | number | focal |
| Name | number | type | R/mm | d/mm | Material | nd | νd | length/mm |
| Physical | | | unlimited | | | | | |
| surface | | | | | | | | |
| The first | JS1 | Spherical | 1.85E+01 | 1.20E+00 | Glass | 1.80 | 46.57 | −7.36 |
| receiving | JS2 | Spherical | 4.29E+00 | 1.56E+00 | | | | |
| lens JL1 | | | | | | | | |
| The second | JS3 | Spherical | 6.87E+00 | 7.38E−01 | Glass | 1.72 | 29.50 | −6.89 |
| receiving | JS4 | Spherical | 2.70E+00 | 1.62E+00 | | | | |
| lens JL2 | | | | | | | | |
| Aperture | JST | | 1.01E+01 | 1.92E+00 | | | | |
| The third | JS5 | Spherical | −2.25E+01 | 2.11E−01 | Glass | 1.72 | 29.50 | 10.29 |
| receiving | JS6 | Spherical | unlimited | 1.32E+00 | | | | |
| lens JL3 | | | | | | | | |
| Fourth | JS7 | Aspheric | −3.19E+01 | 2.89E+00 | Glass | 1.69 | 53.05 | 5.32 |
| receiving | JS8 | Aspheric | −3.37E+00 | 2.11E−01 | | | | |
| lens JL4 | | | | | | | | |
| Fifth | JS9 | Spherical | 6.70E+00 | 3.03E+00 | Glass | 1.72 | 29.50 | 15.35 |
| receiving | JS10 | Spherical | 1.46E+01 | 7.60E−01 | | | | |
| lens JL5 | | | | | | | | |
| Filter SLm | JS11 | Spherical | unlimited | 5.00E−01 | Glass | 1.51 | 62.57 | |
| | JS12 | Spherical | unlimited | 1.10E+00 | | | | |
| Protective | JS13 | Spherical | unlimited | 5.00E−01 | Glass | 1.52 | 64.20 | |
| glass P | JS14 | Spherical | unlimited | 3.45E−01 | | | | |
| Imaging | | | unlimited | 0.000 | | | | |
| surface M | | | | | | | | |

The cone constant K and aspheric coefficient corresponding to the surface of each lens in Example 1 are shown in Table 2.

TABLE 2

| Surface | | | | | | | | |
|---|---|---|---|---|---|---|---|---|
| number | k | A4 | A6 | A8 | A10 | A12 | A14 | A16 |
| JS7 | −2.89E+01 | −8.03E−03 | 1.22E−03 | −9.53E−04 | 2.45E−04 | −2.83E−05 | 0 | 0 |
| JS8 | 1.24E−01 | 2.10E−03 | −5.13E−04 | 1.49E−04 | −1.83E−05 | 9.09E−07 | 0 | 0 |

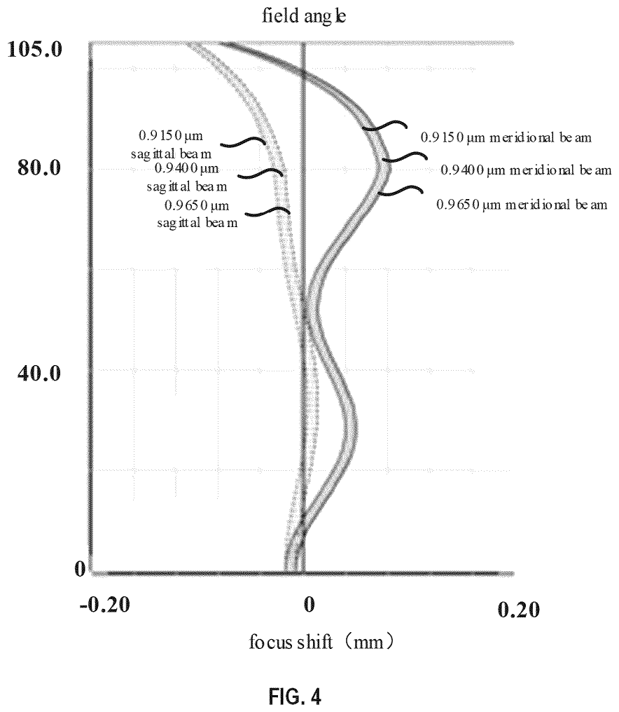

FIG. 4 is a field curvature curve diagram of the receiving lens of the first embodiment. The horizontal axis of the field curvature curve diagram represents the focus offset, and the vertical axis represents the field of view angle. The focus offsets of the sagittal image plane and the meridional image plane of the field curvature curve of the receiving lens given in FIG. 4 at each wavelength are all within +0.12 mm, indicating that the astigmatism of the receiving lens in this embodiment is small and the imaging quality is good.

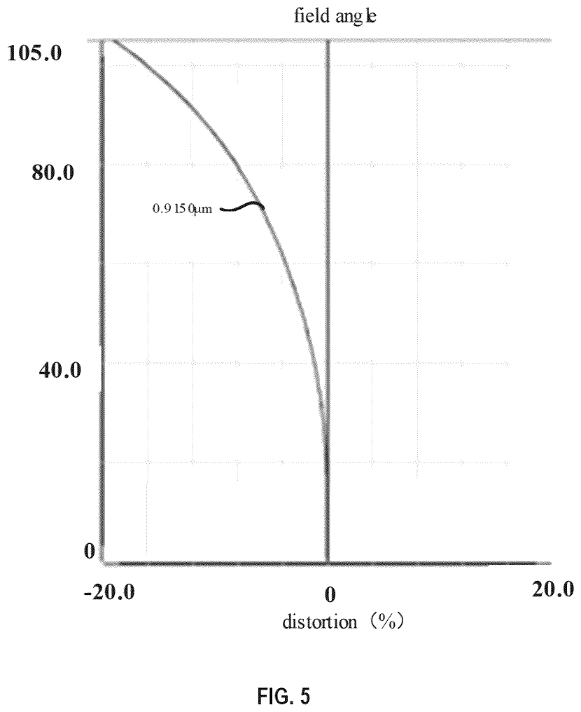

FIG. 5 is a distortion curve diagram of the receiving lens of Example 1. The abscissa of the distortion curve diagram represents the distortion rate, and the ordinate represents the field of view angle. The distortion curve given in FIG. 5 shows that the distortion rate of the edge field of view angle at a wavelength of 0.9650 μm is less than 20%, indicating that the distortion of the receiving lens in this embodiment is well corrected and the imaging quality is good.

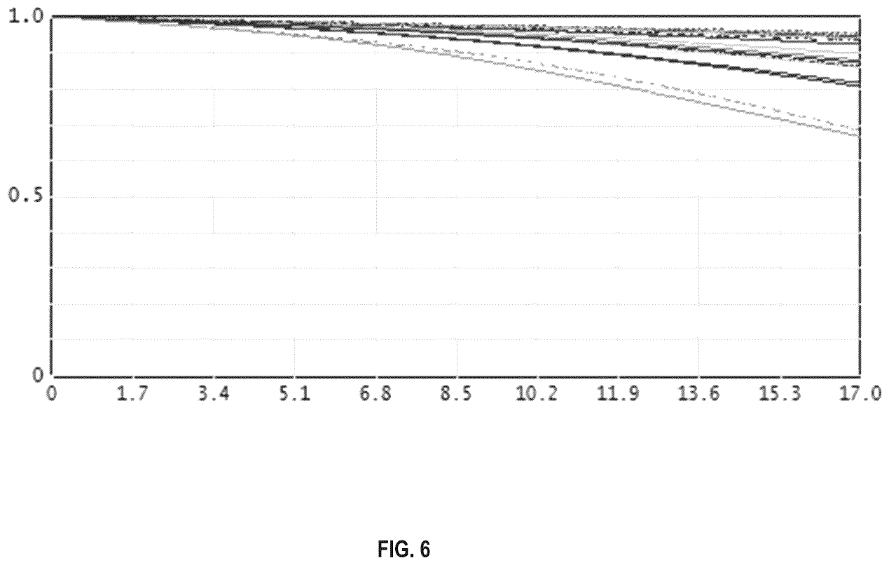

FIG. 6 is a modulation transfer function (MTF) curve of the receiving lens of the first embodiment. FIG. 6 shows the modulation transfer function (MTF) curves of the meridional image plane and the sagittal image plane of the receiving lens at the viewing angle positions of 0.00 mm, 10.00 degrees, 20.00 degrees, 30.00 degrees, 40.00 degrees, 50.00 degrees, 60.00 degrees, 70.00 degrees, 80.00 degrees, 90.00 degrees, 100.00 degrees, and 105.00 degrees, respectively. The solid line is the MTF curve of the meridional image plane, and the dotted line is the MTF curve of the sagittal image plane. Due to the large number of lines, some lines in the figure overlap, but combined with FIG. 6, it can be found that the MTF value is greater than 0.66 when the maximum resolution is 17 lp/mm, and the imaging quality of the receiving lens of the first embodiment is good.

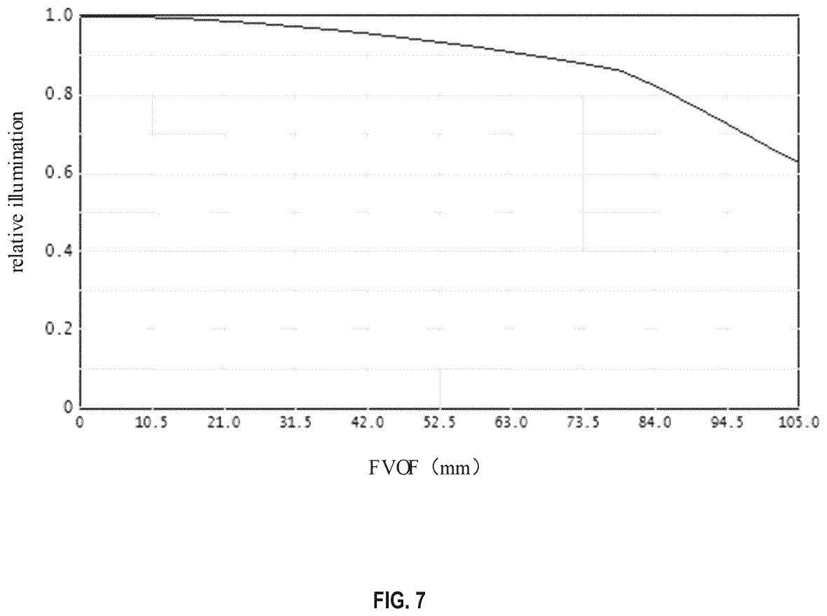

FIG. 7 is a relative illumination curve of the receiving lens of Example 1, where the illumination at a 0° viewing angle is 1, and the illumination at the edge of the viewing field is as close to 1 as possible. The smoother the change in the relative illumination curve, the more uniform the distribution of light projected to the middle area and the edge area of the receiving surface M, and the better the imaging quality. It can be seen from FIG. 7 that the relative illumination of the receiving lens is greater than 82% before the viewing angle is 84°, and the imaging quality of the receiving lens of Example 1 is good.

It can be seen from FIG. 4 to FIG. 7 that the receiving lens can achieve good imaging effect.

### (II) Launch Lens

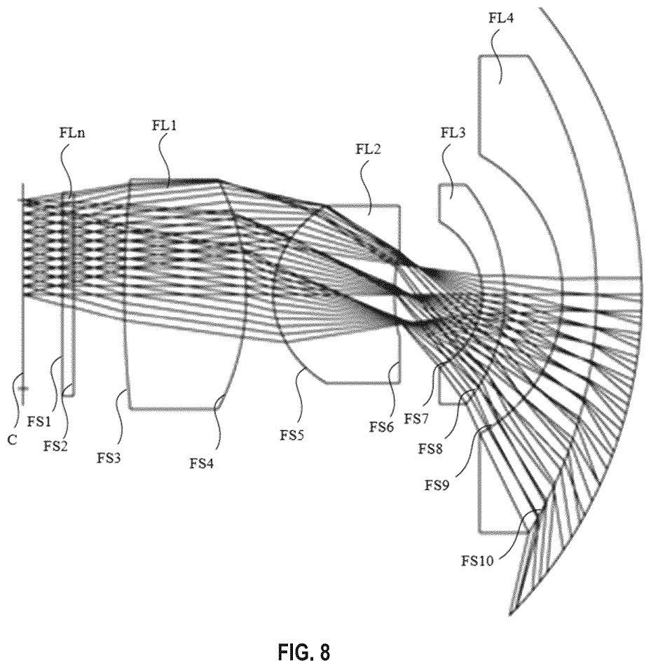

The structural schematic diagram of the emission lens 120, in some embodiments, is shown in FIG. 8, and the emission lens 120 includes a filter SLn, a first emission lens FL1, a second emission lens FL2, a third emission lens FL3, and a fourth emission lens FL4, which are arranged sequentially from the image side to the object side along the optical axis, and the light emitting surface C is located on the side of the filter SLn away from the first emission lens FL1. The filter SLn is a bandpass filter.

The first emission lens FL1 has a positive refractive power, and the image side surface FS3 and the object side surface FS4 of the first emission lens FL1 are both convex at the near optical axis. The second emission lens FL2 has a positive refractive power, the image side surface FS5 of the second emission lens FL2 is convex at the near optical axis, and the object side surface FS6 is concave at the near optical axis. The third emission lens FL3 has a negative refractive power, the image side surface FS7 of the third emission lens FL3 is concave at the near optical axis, and the object side surface FS8 is convex at the near optical axis. The fourth emission lens FL4 has a negative refractive power, the image side surface FS9 of the fourth emission lens FL4 is concave at the near optical axis, and the object side surface FS10 is convex at the near optical axis.

The effective focal length, refractive index, and Abbe number of the emitting lens in Example 1 are based on light with a wavelength of 0.9650 μm. The relevant parameters of the emission lens 120 are shown in Table 3.

In Table 3 and Table 7, the relevant parameters are as follows: fn is the effective focal length of the emission lens 120, TTLn is the total optical length of the emission lens 120, On is half of the maximum field angle of the emission lens 120 in the horizontal direction, h2x is half of the maximum linear dimension of the light emitting surface C of the emission lens 120 in the horizontal direction, and a is half of the incident divergence angle of the emission lens 120.

TABLE 3
Embodiment 1
fn = 2.83 mm; θn = 103.52°; TTLn =
25.34 mm; h 2x = 4.155 mm; α = 30°

| | | | Curvature | | | | Abbe | Effective |
|---|---|---|---|---|---|---|---|---|
| | Surface | Surface | radius | Thickness | | Refractive | number | focal |
| Name | number | type | R/mm | d/mm | Material | index nd | νd | length/mm |
| Light | | | unlimited | unlimited | | | | |
| emitting | | | | | | | | |
| surface | | | | | | | | |
| Filter SLn | FS1 | Spherical | unlimited | unlimited | Glass | 1.51 | 62.57 | |
| | FS2 | Spherical | unlimited | unlimited | | | | |
| First | FS3 | Spherical | 4.63E+01 | 4.63E+01 | Glass | 1.73 | 54.69 | 12.79 |
| emission | FS4 | Spherical | −1.09E+01 | −1.09E+01 | | | | |
| lens FL1 | | | | | | | | |
| Second | FS5 | Aspheric | 4.17E+00 | 4.17E+00 | Glass | 1.69 | 53.05 | 7.34 |
| emission | FS6 | Aspheric | 1.21E+01 | 1.21E+01 | | | | |
| lens FL2 | | | | | | | | |
| The third | FS7 | Spherical | −3.67E+00 | −3.67E+00 | Glass | 1.73 | 54.69 | −10.98 |
| emission | FS8 | Spherical | −7.67E+00 | −7.67E+00 | | | | |
| lens FL3 | | | | | | | | |
| Fourth | FS9 | Spherical | −6.97E+00 | −6.97E+00 | Glass | 1.82 | 46.56 | −14.19 |
| emission | FS10 | Spherical | −1.99E+01 | −1.99E+01 | | | | |
| lens FL4 | | | | | | | | |
| Object side | | | unlimited | 0.000 | | | | |

The cone constant K and aspheric coefficient corresponding to the surface of each lens in Example 1 are shown in Table 4.

TABLE 4

| Surface | | | | | | | | |
|---|---|---|---|---|---|---|---|---|
| number | k | A4 | A6 | A8 | A10 | A12 | A14 | A16 |
| FS5 | −1.22E−01 | −5.55E−04 | 4.77E−05 | −5.88E−06 | 3.02E−07 | −8.68E−09 | 0 | 0 |
| FS6 | −3.80E+01 | 8.72E−03 | −1.96E−03 | 1.56E−03 | −4.83E−04 | 5.39E−05 | 0 | 0 |

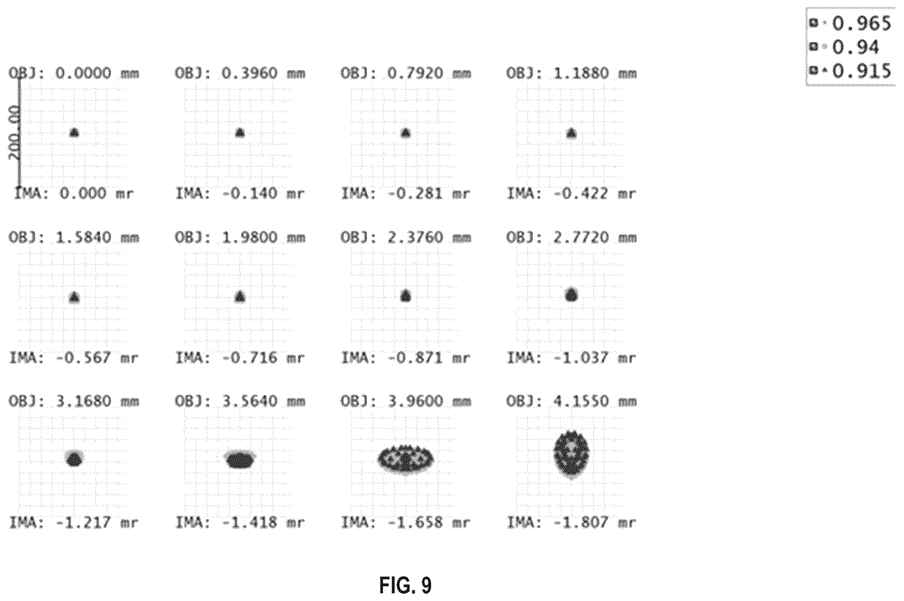

FIG. 9 is a full-field spot diagram of the emission lens of Example 1, obtained through analysis by using ZEMAX software, which shows the distribution of the intersection points of different light rays with the light-emitting surface after passing through the emission lens at different field angles, and the smaller the diffuse spots in the spot diagram, the smaller the aberration. That is, the smaller the values of the RMS radius (root mean square radius) and GEO radius (diameter of all diffuse spots) at the bottom of FIG. 9, the smaller the aberration, that is, the higher the optical performance. It can be seen from the data at the bottom of FIG. 9 that the RMS radius value is always controlled below 25.0 mrad, indicating that the optical performance of the optical system is good.

### Embodiment 2

### (I) Receiving Lens

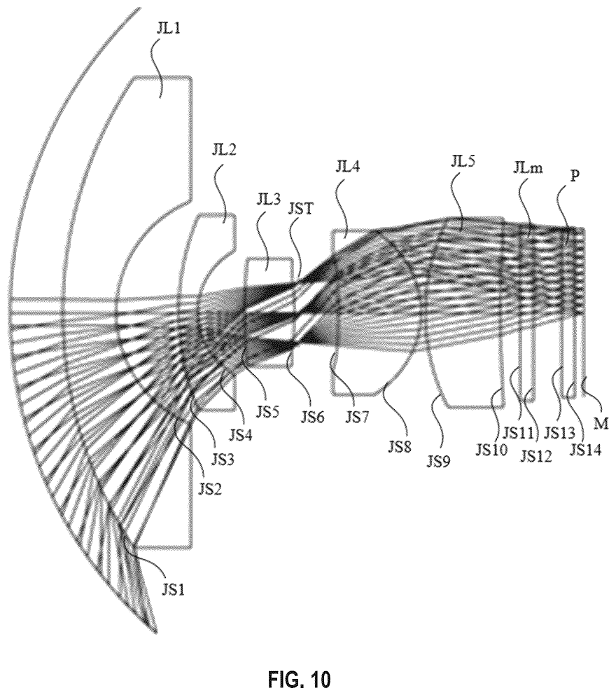

The structural schematic diagram of the receiving lens, in some embodiments, is shown in FIG. 10. The receiving lens includes a first receiving lens JL1, a second receiving lens JL2, a third receiving lens JL3, a fourth receiving lens JL4, a fifth receiving lens JL5, a filter SLm, and a protective glass P arranged sequentially from the object side to the image side along the optical axis. The imaging surface M is located on the side of the protective glass P away from the fifth receiving lens JL5. The aperture ST is arranged between the image side surface JS6 of the third receiving lens JL3 and the object side surface JS7 of the fourth receiving lens JL4. The filter SLm is a bandpass filter.

Among them, the first receiving lens JL1 has a negative refractive power, the object side surface JS1 of the first receiving lens JL1 is a convex surface at the near optical axis, and the image side surface JS2 is a concave surface at the near optical axis. The second receiving lens JL2 has a negative refractive power, the object side surface JS3 of the second receiving lens JL2 is a convex surface at the near optical axis, and the image side surface JS4 is a concave surface at the near optical axis. The third receiving lens JL3 has a positive refractive power, and the object side surface JS5 and the image side surface JS6 of the third receiving lens JL3 are both convex surfaces at the near optical axis. The fourth receiving lens JL4 has a positive refractive power, the object side surface JS7 of the fourth receiving lens JL4 is a concave surface at the near optical axis, and the image side surface JS8 is a convex surface at the near optical axis. The object side surface JS9 of the fifth receiving lens JL5 is a convex surface at the near optical axis, and the image side surface JS10 is a concave surface at the near optical axis.

The effective focal length, refractive index, and Abbe number of the receiving lens in Example 2 are based on light with a wavelength of 0.9650 μm. The relevant parameters of the receiving lens are shown in Table 5.

TABLE 5
Embodiment 2
fm = 1.74 mm; FNO = 1.7; θm = 105°; TTLm = 21.85
mm; h 1x = 3.18 mm; Dm = 17.82 mm; CRA < 1.6°

| | | | Curvature | | | | Abbe | Effective |
|---|---|---|---|---|---|---|---|---|
| | Surface | Surface | radius | Thickness | | Refractive | number | focal |
| Name | number | type | R/mm | d/mm | Material | index nd | νd | length/mm |
| Physical | | | unlimited | | | | | |
| surface | | | | | | | | |
| The first | JS1 | Spherical | 1.60E+01 | 2.03E+00 | Glass | 1.80 | 46.57 | −8.83 |
| receiving | JS2 | Spherical | 4.57E+00 | 2.38E+00 | | | | |
| lens JL1 | | | | | | | | |
| The second | JS3 | Spherical | 9.33E+00 | 7.23E−01 | Glass | 1.72 | 29.50 | −5.60 |
| receiving | JS4 | Spherical | 2.66E+00 | 1.80E+00 | | | | |
| lens JL2 | | | | | | | | |
| Aperture | JST | | 2.12E+01 | 1.89E+00 | | | | |
| The third | JS5 | Spherical | −1.06E+01 | 1.58E−01 | Glass | 1.72 | 29.50 | 10.43 |
| receiving | JS6 | Spherical | unlimited | 1.51E+00 | | | | |
| lens JL3 | | | | | | | | |
| Fourth | JS7 | Aspheric | −6.76E+01 | 3.16E+00 | Glass | 1.69 | 53.05 | 5.25 |
| receiving | JS8 | Aspheric | −3.45E+00 | 1.58E−01 | | | | |
| lens JL4 | | | | | | | | |
| Fifth | JS9 | Spherical | 7.88E+00 | 2.86E+00 | Glass | 1.72 | 29.50 | 13.11 |
| receiving | JS10 | Spherical | 4.93E+01 | 7.60E−01 | | | | |
| lens JL5 | | | | | | | | |
| Filter SLm | JS11 | Spherical | unlimited | 5.00E−01 | Glass | 1.51 | 62.57 | |
| | JS12 | Spherical | unlimited | 1.07E+00 | | | | |
| Protective | JS13 | Spherical | unlimited | 5.00E−01 | Glass | 1.52 | 64.20 | |
| glass P | JS14 | Spherical | unlimited | 3.45E−01 | | | | |
| Imaging | | | unlimited | 0.000 | | | | |
| surface M | | | | | | | | |

The cone constant K and aspheric coefficient corresponding to the surface of each lens in Example 2 are shown in Table 6.

TABLE 6

| Surface | | | | | | | | |
|---|---|---|---|---|---|---|---|---|
| number | k | A4 | A6 | A8 | A10 | A12 | A14 | A16 |
| JS7 | 9.92E+01 | −7.50E−03 | 1.07E−03 | −8.31E−04 | 2.30E−04 | −2.16E−05 | 0 | 0 |
| JS8 | 6.35E−02 | 1.94E−03 | −4.44E−04 | 1.39E−04 | −1.80E−05 | 9.78E−07 | 0 | 0 |

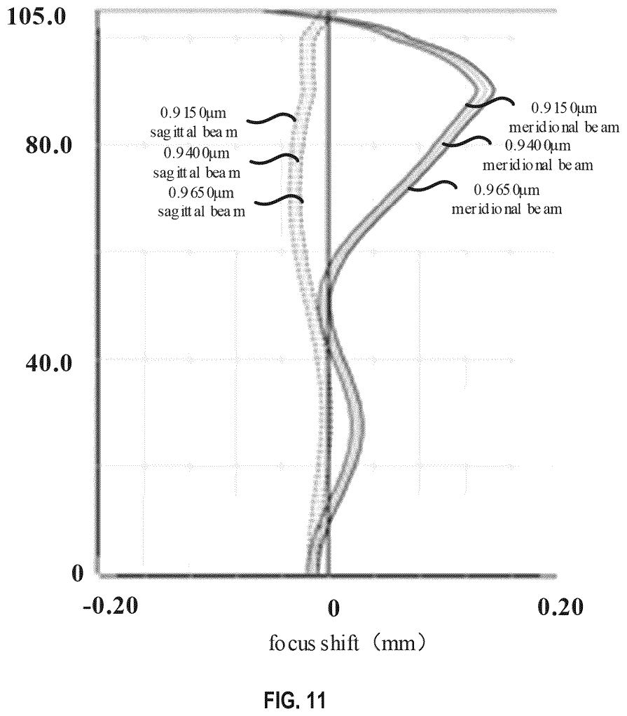

FIG. 11 is a field curvature curve diagram of the receiving lens of the second embodiment. The horizontal axis of the field curvature curve diagram represents the focus offset, and the vertical axis represents the field of view angle. The focus offsets of the sagittal image plane and the meridional image plane of the field curvature curve of the receiving lens given in FIG. 11 are all within ±0.16 mm at each wavelength, indicating that the astigmatism of the receiving lens in this embodiment is small and the imaging quality is good.

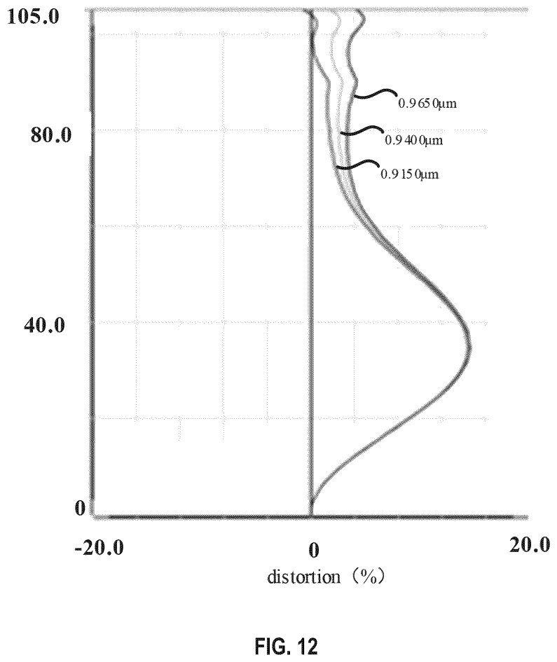

FIG. 12 is a distortion curve diagram of the receiving lens of Example 2. The horizontal axis of the distortion curve diagram represents the distortion rate, and the vertical axis represents the field of view angle. The distortion curve given in FIG. 12 shows that the distortion rate of the edge field of view angle at a wavelength of 0.9650 μm is less than 200%, indicating that the distortion of the receiving lens in this embodiment is well corrected and the imaging quality is good.

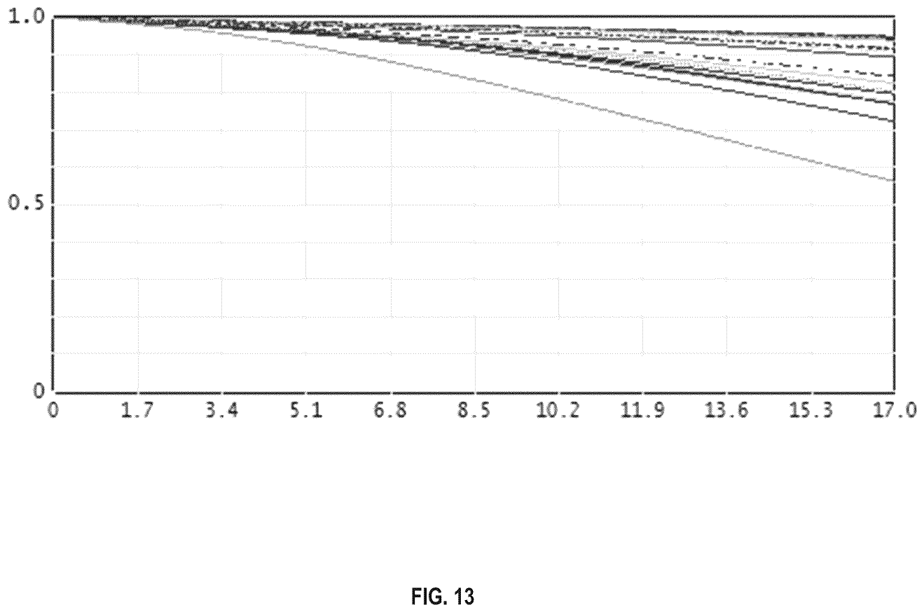

FIG. 13 is a modulation transfer function (MTF) curve of the receiving lens of Example 2. FIG. 13 shows the modulation transfer function (MTF) curves of the meridional image plane and the sagittal image plane of the receiving lens at the viewing angle positions of 0.00 mm, 10.00 degrees, 20.00 degrees, 30.00 degrees, 40.00 degrees, 50.00 degrees, 60.00 degrees, 70.00 degrees, 80.00 degrees, 90.00 degrees, 100.00 degrees, and 105.00 degrees, respectively. The solid line is the MTF curve of the meridional image plane, and the dotted line is the MTF curve of the sagittal image plane. Due to the large number of lines, some lines in the figure are stacked together, but combined with FIG. 13, it can be found that the MTF value is greater than 0.56 when the maximum resolution is 17 lp/mm, and the imaging quality of the receiving lens of Example 2 is good.

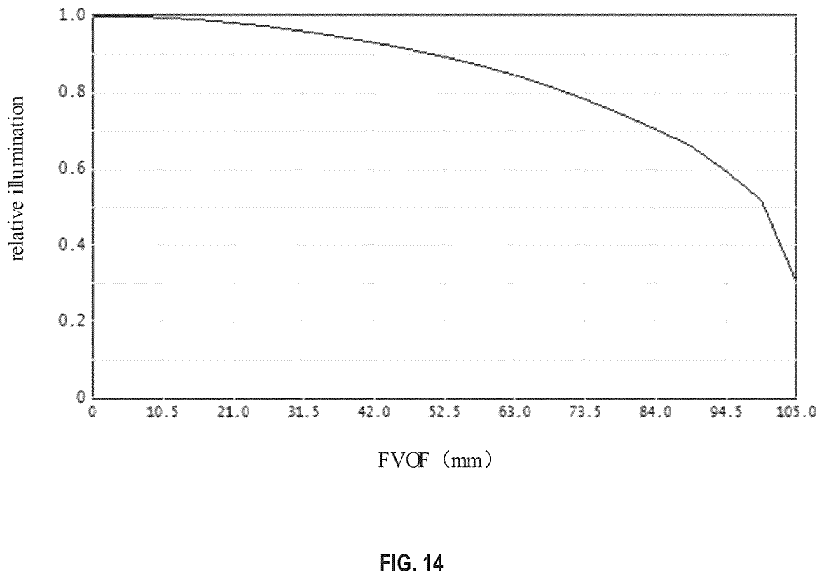

FIG. 14 is a relative illumination curve of the receiving lens of Example 2, where the illumination at a 0° field of view angle is 1, and the illumination at the edge of the field of view is as close to 1 as possible. The smoother the change in the relative illumination curve, the more uniform the distribution of light projected to the middle area and the edge area of the receiving surface M, and the better the imaging quality. It can be seen from FIG. 14 that the relative illumination of the receiving lens is greater than 82% before the field of view angle is 63.0°, and the imaging quality of the receiving lens of Example 2 is good.

It can be seen from FIGS. 11 to 14 that the receiving lens in Example 2 can achieve good imaging effects.

### (II) Launch Lens

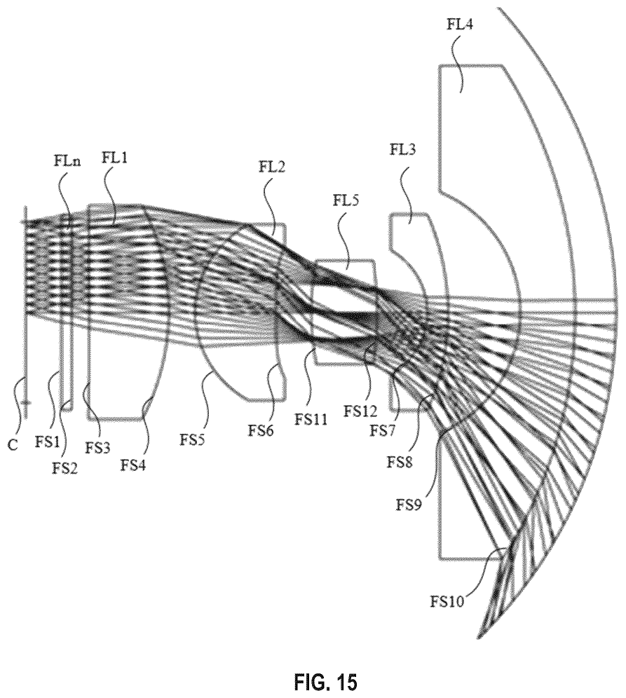

The structural schematic diagram of the emission lens 120, in some embodiments, is shown in FIG. 15. The emission lens 120 includes a filter SLn, a first emission lens FL1, a second emission lens FL2, a fifth emission lens FL5, a third emission lens FL3, and a fourth emission lens FL4, which are sequentially arranged along the optical axis from the image side to the object side, and the light emitting surface C is located on the side of the filter SLn away from the first emission lens FL1. The filter SLn is a bandpass filter.

Among them, the first emission lens FL1 has a positive refractive power, and the image side surface FS3 and the object side surface FS4 of the first emission lens FL1 are both convex at the near optical axis. The second emission lens FL2 has a positive refractive power, and the image side surface FS5 of the second emission lens FL2 is convex at the near optical axis, and the object side surface FS6 is concave at the near optical axis. The fifth emission lens FL5 has a positive refractive power, and the image side surface FS11 and the object side surface FS12 of the fifth emission lens FL5 are both convex at the near optical axis. The third emission lens FL3 has a negative refractive power, and the image side surface FS7 of the third emission lens FL3 is concave at the near optical axis, and the object side surface FS8 is convex at the near optical axis. The fourth emission lens FL4 has a negative refractive power, and the image side surface FS9 of the fourth emission lens FL4 is concave at the near optical axis, and the object side surface FS10 is convex at the near optical axis.

The effective focal length, refractive index, and Abbe number of the emission lens 120 in Example 2 are based on light with a wavelength of 0.9650 μm. The relevant parameters of the emission lens 120 are shown in Table 7.

TABLE 7
Embodiment 2
fn = 2.39 mm; θn = 105°; TTLn =
26.65 mm; h2x = 4.38 mm; α = 30°

| | | | Curvature | | | | Abbe | Effective |
|---|---|---|---|---|---|---|---|---|
| | Surface | Surface | radius | Thickness | | Refractive | number | focal |
| name | number | type | R/mm | d/mm | Material | index nd | νd | length/mm |
| Light emitting | | | unlimited | unlimited | | | | |
| surface | | | | | | | | |
| Filter SLn | FS1 | Spherical | unlimited | unlimited | Glass | 1.51 | 62.57 | |
| | FS2 | Spherical | unlimited | unlimited | | | | |
| First emission | FS3 | Spherical | −3.35E+02 | −3.35E+02 | Glass | 1.72 | 29.50 | 16.44 |
| lens FL1 | FS4 | Spherical | −1.11E+01 | −1.11E+01 | | | | |
| Second emission | FS5 | Aspheric | 4.64E+00 | 4.64E+00 | Glass | 1.69 | 53.05 | 7.12 |
| lens FL2 | FS6 | Aspheric | 7.37E+01 | 7.37E+01 | | | | |
| Fifth emission | FS11 | Spherical | 1.28E+01 | 1.28E+01 | Glass | 1.72 | 29.50 | 11.40 |
| lens FL5 | FS12 | Spherical | −1.87E+01 | −1.87E+01 | | | | |
| The third emission | FS7 | Spherical | −3.47E+00 | −3.47E+00 | Glass | 1.72 | 29.50 | −7.41 |
| lens FL3 | FS8 | Spherical | −1.18E+01 | −1.18E+01 | | | | |
| Fourth emission | FS9 | Spherical | −6.33E+00 | −6.33E+00 | Glass | 1.80 | 46.57 | −12.20 |
| lens FL4 | FS10 | Spherical | −2.20E+01 | −2.20E+01 | | | | |
| Object side | | | unlimited | 0.000 | | | | |

The cone constant K and aspheric coefficient corresponding to the surface of each lens in Example 1 are shown in Table 8.

TABLE 8

| Surface | | | | | | | | |
|---|---|---|---|---|---|---|---|---|
| number | k | A4 | A6 | A8 | A10 | A12 | A14 | A16 |
| FS5 | 5.22E−02 | −4.01E−04 | 5.71E−06 | −4.56E−06 | 5.22E−07 | −2.24E−08 | 0 | 0 |
| FS6 | 1.00E+02 | 3.07E−03 | −2.25E−04 | 1.01E−04 | −1.33E−05 | 5.89E−07 | 0 | 0 |

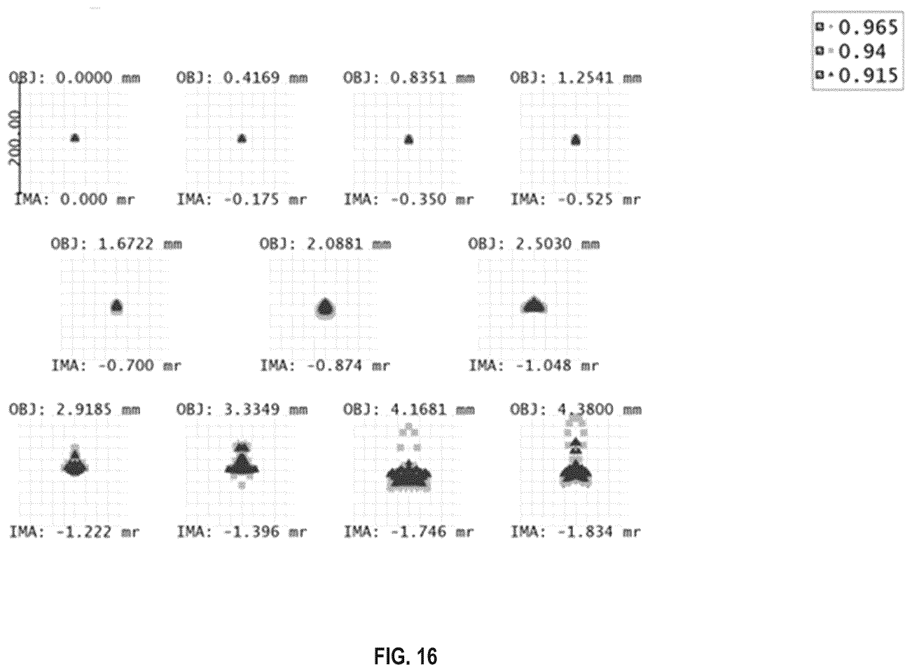

FIG. 16 is a full-field point diagram of the emission lens of Example 2. It can be seen from the data at the bottom of FIG. 16 that the RMS radius value is always controlled below 25.5 mrad, indicating that the optical performance of the optical system is good.

The same or similar reference numerals in the drawings of the present application refer to the same or similar parts. In the description of the present application, it should be understood that if the terms “upper,” “lower,” “left,” “right,” and the like indicate directions or positional relationships based on the directions or positional relationships shown in the drawings. These terms are not intended to indicate or imply any particular spatial orientation or specific mode of construction or operation of the referenced device or component. Accordingly, such directional terms are intended only for illustrative purposes and should not be construed as limiting the scope of the present application. Those skilled in the art will understand the appropriate interpretation of such terms based on the particular context in which they are used.

The above description is provided merely as exemplary embodiments of the present application and is not intended to limit the scope of the present application. Any modifications, equivalent substitutions, and improvements that fall within the spirit and scope of the present application shall be encompassed within the scope of protection as defined by the appended claims.

What is claimed is:

1. A laser transceiver module, comprising a receiving lens and a receiver, wherein the receiving lens is configured to receive an echo light formed after a detection light is reflected by a target object, the receiver has an imaging surface, and the echo light converges on the imaging surface; and
wherein the receiving lens satisfies a conditional formula: 1.70 mm≤fm≤2.30 mm, 1≤Fm≤1.7, wherein fm is an effective focal length of the receiving lens, and Fm is an F value of the receiving lens.

2. The laser transceiver module according to claim 1, wherein the receiving lens comprises a first receiving lens, a second receiving lens, a third receiving lens, a fourth receiving lens, and a fifth receiving lens arranged along an optical axis;
wherein respective distance values from the first receiving lens to the receiver, from the second receiving lens to the receiver, from the third receiving lens to the receiver, from the fourth receiving lens to the receiver, and from the fifth receiving lens to the receiver decrease sequentially;
wherein the first receiving lens and the second receiving lens have negative refractive power, while the third receiving lens, the fourth receiving lens, and the fifth receiving lens have positive refractive power; and
wherein the fourth receiving lens is an aspherical lens.

3. The laser transceiver module according to claim 2, wherein the receiving lens satisfies following conditions: 1.0≤fm1/fm2≤2.0, −1.0≤fm2/fm3≤−0.3, 1.6≤fm3/fm4≤2.1, 0≤fm4/fm5<0.5,
wherein fm1 is a focal length of the first receiving lens, fm2 is a focal length of the second receiving lens, fm3 is a focal length of the third receiving lens, fm4 is a focal length of the fourth receiving lens, and fm5 is a focal length of the fifth receiving lens.

4. The laser transceiver module according to claim 1, further comprising an emission lens and an emitter, wherein:
the emission lens is configured to transmit the detection light generated by the emitter to the target object, the emitter has a light emitting surface, and the detection light is emitted from the light emitting surface; and
the emission lens satisfies the condition: 2.0 mm≤fn≤2.90 mm, wherein fn is an effective focal length of the emission lens.

5. The laser transceiver module according to claim 4, wherein the emission lens comprises a first emission lens, a second emission lens, a third emission lens, and a fourth emission lens arranged along an optical axis; respective distance values from the first emission lens to the emitter, from the second emission lens to the emitter, from the third emission lens to the emitter, and from the fourth emission lens to the emitter increase sequentially;
wherein the first emitting lens and the second emitting lens have positive refractive power, and the third emitting lens and the fourth emitting lens have negative refractive power; and
wherein the first emitting lens or the second emitting lens is an aspherical lens.

6. The laser transceiver module according to claim 5, wherein the emission lens satisfies: 1.6≤fn1/fn2≤1.9, −0.8≤fn2/fn3≤−0.4, 0.5≤fn3/fn4≤0.8, and
wherein fn1 is a focal length of the first emitting lens, fn2 is a focal length of the second emitting lens, fn3 is a focal length of the third emitting lens, and fn4 is a focal length of the fourth emitting lens.

7. The laser transceiver module according to claim 5, wherein the emission lens further comprises a fifth emission lens disposed between the second emission lens and the third emission lens, a focal length of the fifth emission lens being fn5; and
wherein the emission lens satisfies: 12.1≤fn1/fn2≤2.5, 0.6≤fn2/fn5≤0.8, 1.4≤fn5/fn3≤1.7, 0.5≤fn3/fn4≤0.7.

8. The laser transceiver module according to claim 4, wherein the receiving lens and the emission lens are arranged side by side in a vertical direction, and the optical axis of the receiving lens is parallel to the optical axis of the emission lens and both are perpendicular to the vertical direction.

9. The laser transceiver module according to claim 8, wherein:
the lens of the receiving lens has a first plane parallel to the optical axis of the receiving lens, and the first plane is perpendicular to the vertical direction; or
the lens of the emitting lens has a second plane parallel to the optical axis of the emitting lens, and the second plane is perpendicular to the vertical direction.

10. A LiDAR, comprising:
a laser transceiver module; and
a shell configured for accommodating the laser transceiver module,
wherein the laser transceiver module comprises a receiving lens and a receiver, wherein the receiving lens is configured to receive an echo light formed after a detection light is reflected by a target object, the receiver has an imaging surface, and the echo light converges on the imaging surface; and
wherein the receiving lens satisfies a conditional formula: 1.70 mm≤fm≤2.30 mm, 1≤Fm≤1.7, wherein fm is an effective focal length of the receiving lens, and Fm is an F value of the receiving lens.
